(19) United States
(12) Patent Application Publication
(10) Pub. No.: US 2015/0025804 A1
(43) Pub. Date: Jan. 22, 2015

(54) Device And Method For Measuring Wave Motion

(71) Applicants: Craig A. Jones, Santa Cruz, CA (US); Grace Chang Spada, Santa Barbara, CA (US)

(72) Inventors: Craig A. Jones, Santa Cruz, CA (US); Grace Chang Spada, Santa Barbara, CA (US)

(73) Assignee: SEA ENGINEERING INC., Honolulu, HI (US)

(21) Appl. No.: 14/338,259

(22) Filed: Jul. 22, 2014

Related U.S. Application Data
(60) Provisional application No. 61/857,057, filed on Jul. 22, 2013.

(51) Int. Cl. G01C 13/00

(52) U.S. Cl. CPC G01C 13/002
USPC 702/2

(57) ABSTRACT

Embodiments are directed towards a wave measuring electronics device that is integrated within a buoy and the buoy is moored in an ocean. The wave measurement device performs a computer-implemented method for estimating wave motion, including receiving 3D sensor data from each of an accelerometer and a gyroscope, determining, an absolute orientation of the buoy based on said 3D sensor data; and estimating, the true earth acceleration of the buoy over a specified time interval.

### REFERENCE TO RELATED APPLICATIONS

This application claims benefit of U.S. Provisional Application No. 61/857,057, entitled A Device And Method For Measuring Wave Motion, filed on Jul. 22, 2013 by inventor Craig A. Jones.

### GOVERNMENT LICENSE RIGHTS

This invention was made with government support under ARPA-E Award No. DE-AR0000305 awarded by THE U.S. Department of Energy. The government has certain rights in the invention.

### BACKGROUND

Spectral approaches to estimating wave motion based on surface following buoy motions have been known for over 50 years. However, there have not been good solutions for obtaining accurate estimates of wave motion in real-time based on sensors embedded in surface following ocean buoys.

The present industry standard surface wave measurement devices, referred to hereinbelow as “standard buoys,” perform surface measurements of wave elevation, acceleration, and surface tilts from horizontal directions to determine a non-directional, or omnidirectional, wave spectrum or a directional wave spectrum. A standard buoy uses a combination of custom designed sensors including multi-axis accelerometers, compass, and other sensors to derive buoy motions. These custom designed sensors have a high cost and are physically limited in the range of measurements they can make. These custom sensors subsequently increase the overall expense and limit the quality of the motion sensing data they can measure.

The book entitled Waves in Ocean Engineering by M. J. Tucker and E. G. Pitt, published in 2001 in the Elsevier Ocean Engineering Series, henceforth [Tucker and Pitt, 2001], describes basic wave spectra terminology and equations including the omnidirectional wave spectrum, S(f), and the directional wave spectrum, S(f,θ), in pages 30-42, which are incorporated herein by reference.

Additionally, as described in U.S. Pat. No. 8,195,395 by Chung-Chu Teng, et al., recent state-of-the art methods for computing directional wave spectra, in which the processing of buoy pitch and roll is based on acceleration alone, limit the fidelity and quality of the derived wave motion. For example such methods have the potential for singularities such as gimbal lock and may introduce excess noise due to the reliance on one set of sensor data, namely, sensor data from an accelerometer, to determine rotation.

The processing based on measurements from these custom sensors is limited to spectral components which limit the capabilities to wave measurements over longer periods of time (typically 20 minutes). Thus, prior art approaches are not capable of providing an accurate estimate of directional wave motion in real-time.

Recently low cost, low power and low weight micro-electromechanical systems (MEMS) have become available. Such MEMS have been used in a wide range of applications such as virtual reality and computing gaming. However, the signal output of such MEMS are typically low resolution and are subject to high noise levels. Thus the raw signal must be processed to obtain accurate measurements. Various methods for processing MEMS sensor data and mapping the data onto a fixed x-y-z reference have been published, such as described in the publication “Nonlinear Complementary Filters on the Special Orthogonal Group”, by Robert Mahony et al., published in IEEE Transactions on Automatic Control, Vol. 53, No. 5, June 2008, referred to herein as [Mahony, 2009], which is included by reference herein.

Another approach, that uses a gradient descent algorithm, is provided by Madgwick, S., Harrison, A., and Vaidyanathan, R., entitled “Estimation of IMU and MARG orientation using a gradient descent algorithm”, 2011 IEEE International Conference on Rehabilitation Robotics Rehab Week Zurich, ETH Zurich Science City, Switzerland, June 29-July 1, referred to herein as [Madgwick, 2011], which is included herein by reference.

Thus, it is with respect to these considerations and others that the present invention has been made.

### SUMMARY OF THE DESCRIPTION

Various embodiments are directed towards a wave measuring electronics device that is integrated within a buoy. The subject invention provides full 3-dimensional motion detection through the real-time fusion of MEMS sensor data. By utilizing software algorithms that process this sensor data, accurate wave motion information is obtained.

The subject invention concerns the accurate measurement of surface water waves based on sensor data from motion sensors housed in a buoy or other surface following apparatus. The wave measurement device provides a technical innovation by incorporating micro-electromechanical systems (MEMS), and processing the sensor data from the MEMS using a novel combination of motion algorithms to determine accurate wave motion in real-time.

In one embodiment, the invention is implemented inside a buoy that is moored in the ocean or other body of water. In another embodiment, the invention may be implemented as computer software that runs in a computer and receives or has access to sensor data obtained elsewhere.

In one embodiment, the subject invention integrates wave measurement sensors with a processor, data storage, and communication systems. The sensors include, at a minimum, one or more 3-axis accelerometers and one or more 3-axis gyroscopes. In cases where directional wave measurement is desired a 3-axis magnetometer is also included and sensor data from the magnetometer is used to compute a directional spectral density, referred to as S(f,θ).

Optionally, a Global Positioning System (GPS) for position tracking can be included.

Onboard processing is performed to derive wave parameters, including inter alia wave height, period, and directional wave spectra and global positioning if a GPS is deployed. The subject invention is designed for deployment inside a buoy; however, it's use is not limited to buoys and it can also be deployed inside stationary ships, beacons and any other water surface following object.

Certain embodiments are directed towards a wave measuring electronics device that is integrated within a buoy and the buoy is moored in an ocean. The wave measurement device performs a computer-implemented method for estimating wave motion, including receiving 3D sensor data from each of an accelerometer and a gyroscope, determining, an absolute orientation of the buoy based on said 3D sensor data; and estimating, a true earth acceleration of the buoy over a specified time interval.

In certain embodiments, the buoy also includes a magnetometer, in which case the method may additionally calculate a power spectral density of acceleration in the frequency domain, and compute an omnidirectional wave energy spectrum.

Additional embodiments of the subject invention are directed towards a buoy that estimates wave motion, including a housing, a power source, attached to the housing, an inertial measurement unit, attached to the housing, that includes an accelerometer and a gyroscope, each of which provides a time series of 3D sensor data, a data storage for storing program code and data, and a processor in communication with the inertial measurement unit and the data storage, that is programmed to perform instructions that cause the processor to determine an absolute orientation of the buoy based on said 3D sensor data, and to estimate the true earth acceleration of the buoy over a specified time interval.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a wave measurement device integrated within a buoy.

FIG. 2 is a block diagram that illustrates one embodiment of a wave measurement device capable of being integrated within a buoy that measures wave data.

FIG. 3 illustrates one embodiment of a software architecture for a wave measurement device.

FIG. 4 provides an overall flowchart of the steps performed by a wave measurement device to measure and estimate wave data.

FIG. 5A provides an example of the power spectral density of the measured acceleration in FIG. 5B collected using the device.

FIG. 5B provides an example of a measured time series of acceleration, used to compute the power spectral density of acceleration in FIG. 5A.

FIG. 5C provides an example of a power spectral density of velocity calculated from the power spectral density of acceleration illustrated in FIG. 5A.

FIG. 5D provides an example of a time series of velocity determined from the power spectral density of velocity FIG. 5C.

FIG. 5E provides an example of a power spectral density of displacement, referred to as a wave spectrum, S(f).

FIG. 5F provides a time series of wave displacement, calculated from the power spectral density of displacement, S(f), illustrated in FIG. 5E.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Buoy—a waterproof apparatus that floats on the surface of a body of water. For the purpose of this invention a buoy refers to a physical structure that is designed to include an electronics device that measures wave data. A buoy may be a commercial or custom device or it may also refer to a different type of apparatus, such as a boat or raft that for purposes of the present invention acts as a buoy.

### Generalized Operation

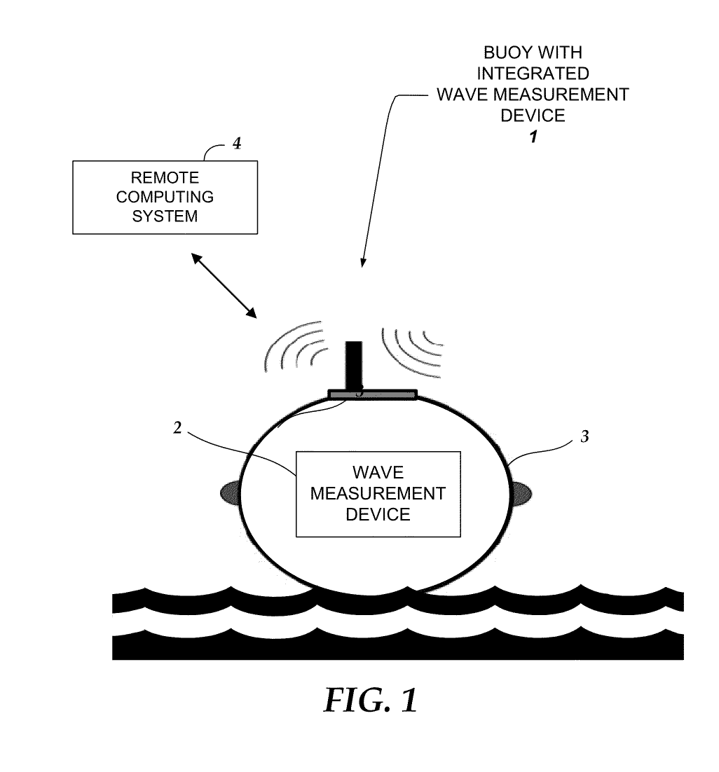

The operation of certain aspects of the invention is described below with respect to FIGS. 1-5.

FIG. 1 is a generalized block diagram of a wave measurement device 2 integrated within a buoy housing 3. In one embodiment, the invention takes the form of an integrated system, i.e. buoy 1 with an integrated wave measurement device 2. In other embodiments, the invention is confined to wave measurement device 2, in a form that is suitable for integration into buoy housings such as buoy housing 3.

To initiate operation of wave measurement device 2, a user or operator, referred to hereinbelow simply as a user, installs a new battery or power source in wave measurement device 2 if necessary and powers it up by pressing a button or on/off switch or other operational control. Wave measurement device 2 is then setup via a software interface through a communications cable or wireless link. The user selects time periods for sampling, sampling interval, parameters to be measured, and data storage (i.e. data logging) and data transmission options. It may be appreciated the in other embodiments wave measurement device may be activated remotely, for example using a wireless signal.

Once wave measurement device 2 is activated, buoy 1 is deployed on the surface of a body of to sense the motion of the surface of the water and to measure wave activity. Buoy 1 floats on the water surface. While buoy 1 is typically moored, it will also function properly when drifting on the ocean surface, i.e. without being moored. Upon deployment, buoy 1 collects data through various motion sensors. Buoy 1 is deployed for a period of time over which the user wishes to measure waves. During deployment, wave measurement device 2 obtains data through various sensors, processes the data to measure or estimate wave motion, and stores the data in an onboard data storage subsystem. In addition, buoy 1 may transmit the raw and/or processed data wirelessly to a remote computing system 4 which may display the received data or further process it. Remote computing system 4 may comprise one or more receiving stations that receive the transmitted data and relay it to remote computing system 4. In contrast to prior art buoys, in the subject invention the data may be completely processed on board by wave measurement device 2 and then stored or transmitted to remote computing system 4. Prior art buoys typically partially process the data, then transmit the results to shore, or store the data onboard to be processed later by another device.

Upon completion of the measurement period, buoy 1 is retrieved from the water. Wave measurement device 2 may then be interfaced with via a cable or wireless link to another computing device so that stored data can be retrieved from the onboard data storage subsystem. Wave measurement device 2 can then be powered off for future deployment.

Wave measurement device 2 may be attached to or integrated with other moving devices. In this way, the invention could be used to sense the motion of any moving body. Example applications include attaching wave measurement device 2 to existing navigation buoys, ships, recreational vessels, debris, and other buoyant bodies that move with the water.

### Architecture

A basic measurement goal of wave measurement device 2 is to generate rotation and acceleration data for buoy 1 in a fixed x-y-z plane. To accomplish this, an accelerometer measures the local acceleration in the x-y-z directions, generating a time series of 3D sensor data, i.e. x, y, z axis, while a gyroscope measures 3D angular velocity for the x-y-z axes. The accelerometer and gyroscope are the primary sources of 3-dimensional (3D) orientation information. From the accelerometer and gyroscope information, a rotation matrix can be developed describing the relationship between the local coordinate system of buoy 1 and the Earth's fixed coordinate system. In a preferred embodiment, a directional cosine rotation matrix, hereinafter referred to as a rotation matrix, an algorithm used in aircraft navigation, is used to compute the orientation of buoy 1 within the Earth's fixed coordinate system. From the rotation matrix and a complimentary filter the accelerations describing the buoy 1 motion are mapped onto the fixed x-y-z reference. In the most basic embodiment, this provides a true vertical acceleration (i.e. heave) in the z axis. The rotation matrix can additionally be used to tilt correct magnetometer readings so that a magnetic directional reference, based on the magnetometer's measurements of the Earth's magnetic flux field, can be applied to the fixed x-y-z. Additionally, a directionally referenced x, y, z acceleration and roll and pitch measurement can be obtained. Other methods than a rotation matrix may also be used to map sensor data onto a fixed x-y-z reference, including complimentary filters, such as described in [Mahony, 2008], and quaternions without departing from the scope and spirit of the subject invention.

It may be appreciated by one skilled in the art that there are other techniques that may be used to represent orientation other than the rotation matrix, including inter alia Kalman based algorithms and quaternions. Further, such other techniques may be used without departing from the spirit and scope of the present invention.

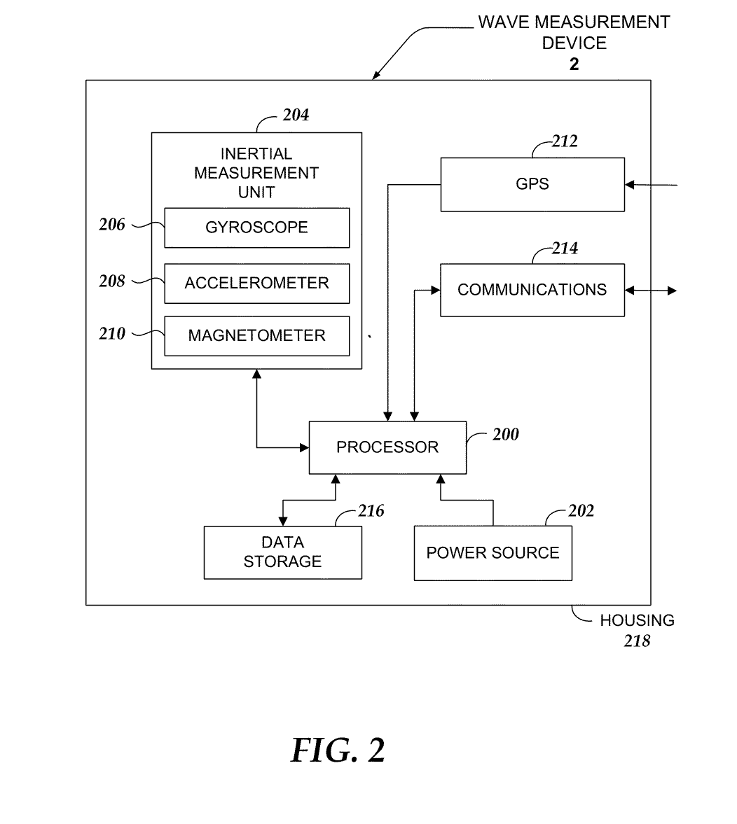

FIG. 2 is a block diagram that illustrates one embodiment of wave measurement device 2 which is capable of being integrated within a buoy and which measures wave data.

Inertial measurement unit 204 includes sensors that provide data for 3-axes (x, y, z). The sensors include one or more of a gyroscope 206, an accelerometer 208, and a magnetometer 210 all mounted on one or more circuit boards (not depicted) and connected to processor 200. It may be appreciated that modern MEMS sensors provide 3-axis measurements. In other embodiments, 3 sensors, each of which provides sensor data for one axis, may be required for each of gyroscope 206, accelerometer 208, and magnetometer 210.

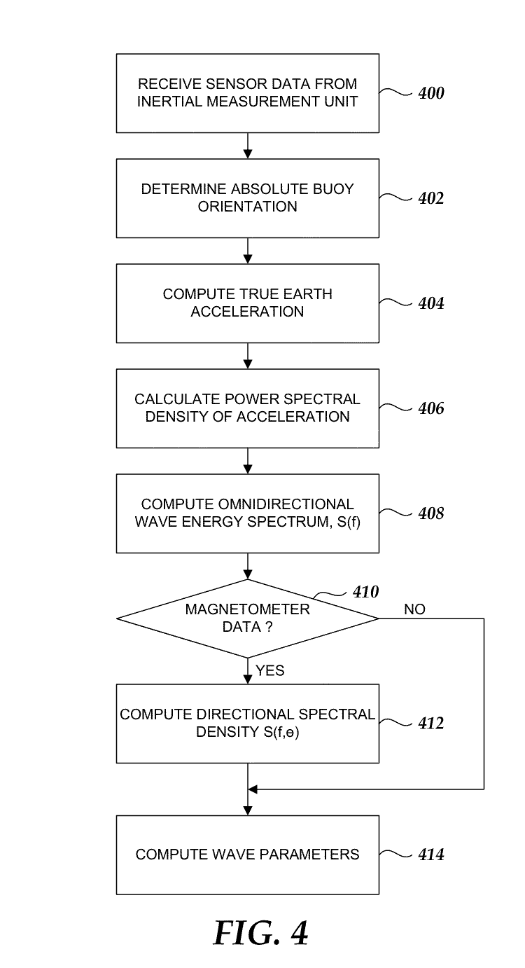

Processor 200 interfaces with and powers an inertial measurement unit 204. Processor 200 receives the sensor data from inertial measurement unit 204 and implements algorithms to process the data. One embodiment of such processing is illustrated in the flow chart of FIG. 4. In certain embodiments, processor 200 is implemented as one or more commercial microprocessors, for example, by one or more ATMEL AVR microcontrollers, available from the Atmel Corporation. Typically, such a microcontroller is programmed using a programming language such as the C programming language. Alternatively processor 200 may be implemented using a custom microcontroller, or by a plurality of processors that operate cooperatively.

Processor 200 is provided power via a power source 202. An example of power source 202 is a DC battery. Solar cells mounted on buoy 1 may also serve as power source 202, or may be used to recharge power source 202. A device that converts wave power to electricity may also serve as power source 202 or may recharge power source 202.

Communications subsystem 214 transmits data from data storage 216 to an external device. In one embodiment communications 214 provides a physical connection, for example by implementing a USB interface. In other embodiments, near field communication such as BLUETOOTH are used; in still other embodiments, communication subsystem 214 is capable of communicating remotely to a device on land or on a ship using RF communications or satellite communications. One example of a satellite communication system that may be used for this purpose is the IRIDIUM satellite network that covers the Earth operated by Iridium Communications Inc. of McLean, Va.

Wave measurement device 2 may include a GPS unit 212. When GPS unit 212 is included it obtains position data from the Global Positioning System operated by the U.S. Department of Defense for position tracking of buoy 1. GPS may be used, for example, to track and recover buoy 1 in the event that it becomes unmoored.

A housing 218 provides a waterproof enclosure within buoy 3 that houses items 204-216. Housing 218 is typically fabricated from stainless steel, plastic or another water resistant, non-corrosive material. All components of wave measurement device 2 are securely mounted within the housing which is set inside buoy 3. In certain embodiments, wave measurement device housing 218 includes a structure for securing one or more printed circuit boards and a waterproof box in which the electronics may be mounted.

Inertial measurement device 204 includes several sensors, including a gyroscope 206, an accelerometer 208 and optionally a magnetometer 210. Each of sensors 206-210 is connected to processor 200 which provides power to the sensors and allows for two-way communication with the sensors. Processor 200 is programmed to activate sensors 206-210 and obtain sensor data from them at up to 50 Hz, depending on the configuration. Processor 200 processes the sensor data to obtain wave data.

A data storage 216 subsystem is also connected to processor 200 enabling processor 200 to store sensor data and processed data for later retrieval. Data storage 216 provides nonvolatile storage for data and program code. Such storage may be in the form of inter alia random access memory (RAM), read only memory (ROM), flash memory, or disk storage.

A variety of alternative hardware configurations are possible without departing from the spirit and scope of the subject invention. While it is expected that a minimum hardware configuration will include an accelerometer, gyroscope, and power source, other components can be omitted in certain other embodiments. For example, data storage may be omitted if sensor data and processed results are transmitted wirelessly in real time. Further wireless communication may be omitted in configurations where data is downloaded from wave measurement device 2 after buoy 1 is retrieved. The magnetometer can be omitted and allow the device to still measure waves without direction.

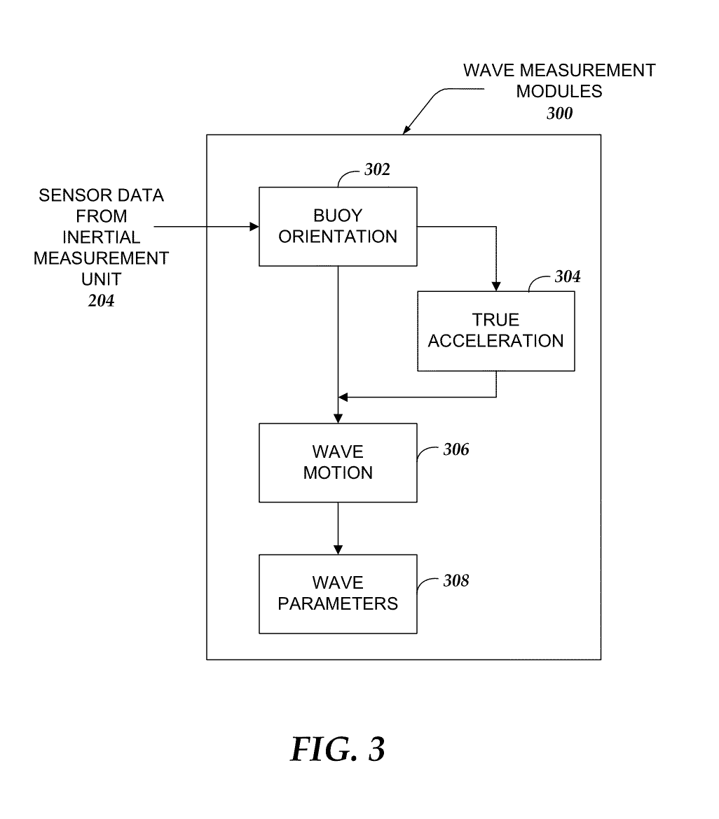

FIG. 3 illustrates one embodiment of a architecture for wave measurement device 2. During normal operation, accelerometer 208 detects relative acceleration of buoy 1 in the x, y, and z direction. Gyroscope 206 detects the angular motion of buoy 1 around the x, y, and z axis. Magnetometer 210 measures the Earth's magnetic flux field with reference to buoy 1. Inertial measurement unit 204 provides this sensor data to a buoy orientation module 302. It may be appreciated FIG. 3 describes an embodiment of a software architecture in which discrete functions are performed by different modules; in other embodiments, functions may be assigned in different ways to software modules. In yet other embodiments, some of the functions may be implemented in hardware or firmware, or in whole or in part by remote computers or cloud computing services.

Buoy orientation module 302 performs a rotation matrix algorithm in real-time to determine the absolute buoy orientation based on rotation measurements provided by the sensors in inertial measurement unit 204. This is a distinction from standard wave buoys which use only the acceleration to determine the pitch and roll of the buoy.

A true acceleration module 304 computes the true earth accelerations based on the three components of acceleration provided by the sensors in inertial measurement unit 204 and the buoy orientation determined by buoy orientation module 302. The vertical acceleration provides the primary measure of the vertical buoy motion, i.e. motion in the z direction, also referred to as heave. The horizontal components of buoy acceleration referenced to magnetic or true North, i.e. acceleration components in the x-y plane or the north-south east-west plane, are obtained by incorporating magnetometer sensor data. Thus, the processing performed by true acceleration module 304 results in an acceleration time series, z(t), in the vertical direction, and additionally x(t) and y(t) acceleration time series that indicate directionally referenced horizontal acceleration, when magnetometer data is used.

A wave motion module 306 uses the vertical acceleration data computed by true acceleration module 304 to determine the short-term change in elevation of the sea surface.

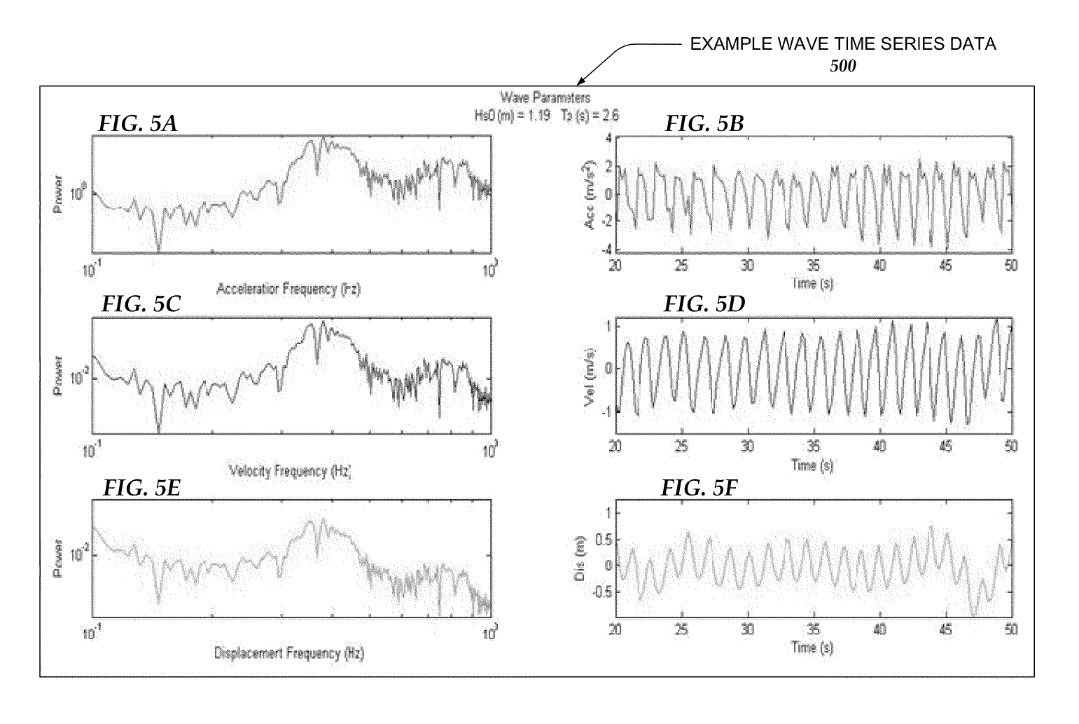

In one embodiment, wave motion module 306 implements a Fast Fourier Transform (FFT) of the time series acceleration data provided by true acceleration module 304 to compute a power spectral density (PSD) of acceleration that estimates wave motion in the frequency domain. An example of such a power spectral density of acceleration is illustrated hereinbelow in FIG. 5A. The PSD is then double integrated to determine a wave spectrum S(f). S(f) is generally referred to as the non-directional, or omnidirectional, wave spectrum or spectral density, function and has units of m²/Hz. An example, of such a wave spectrum, S(f), is illustrated hereinbelow in FIG. 5E. Other transforms and filters, other than FFT, may also be used to transform time series data to frequency domain data.

By determining spectral moments, a wave parameters module 308 estimates or determines common wave parameters. The zero order moment can be defined by:

m₀=∫₀^{∞}S(f)df (Equation 1)

Using the spectral moments of S(f), common wave parameters of interest can be defined. For example, wave parameters module 308 may compute the significant wave height, where in one embodiment significant wave height is defined as the average height of the highest ⅓ of waves during a time interval. This is formulated in Equation 2 below as:

Hₘ₀=4\sqrt{m₀} (Equation 2)

By means of wave spectrum, S(f), typical wave parameters such as the significant wave height can be determined from the vertical acceleration (i.e. heave). An example of the output of the FFT and measured water surface acceleration and derived velocity and displacement data are shown in FIG. 5.

Based on the sensor data from both accelerometer 208 and gyroscope 206 the buoy orientation can be determined. Using the true earth vertical acceleration determined from this orientation a non-directional wave spectra, S(f), may be computed. When combined with sensor data from magnetometer 210 the horizontal accelerations in the north and east direction can be obtained and are used to compute the directional spectra of the waves 306. When the true earth directional components of acceleration are included into the processing, additional wave information can be obtained. As described in [Tucker and Pitt, 2001] the directional spectral density can be defined by:

S(f,θ)=S(f)G(θ) (Equation 3)

where G(θ) defines the directional distribution, also as specified in [Tucker and Pitt, 2001].

The wave motion data provided by wave parameters module 308 may include the significant wave height and peak period over some time interval of interest, displacement in the true earth x, y, and z directions, and the wave spectral energy parameters outlined above. All of the raw sensor data, provided by inertial measurement unit 204, may also be recorded so that post-processing such as error analysis and the derivation of other motion parameters can be conducted.

FIG. 4 provides an overall flowchart of the steps performed by a wave measurement device to measure and estimate wave data. At step 400 sensor data is received from sensors in inertial measurement unit 204. At step 402 the absolute buoy orientation is computed real-time using the sensor data. As discussed previously, in certain embodiments this is performed using a rotation matrix. In another embodiment, a direct cosine matrix with a complimentary filter is used for this purpose; however, a quaternion formulation may also be used [Madgwick, 2011]. At step 404 an true earth accelerations are estimated by true acceleration module 304. At step 406 the power spectral density of acceleration is calculated. As previously discussed this step is typically performed using a Fast Fourier Transform (FFT) algorithm. At step 408 the wave energy spectrum, S(f), is computed. Steps 406-408 are performed by wave motion module 306.

At step 410 a determination is made as to whether sensor data from magnetometer 210 is available. If so, then at step 412 a directional spectral density, S(f,θ), is computed. If inertial measurement unit 204 doesn't include a magnetometer or if for any reason magnetometer sensor data is not available then step 412 is skipped and processing continues at step 414. Finally, at step 412 a variety of wave parameters are computed. As discussed relative to wave parameters module 308 wave parameters may include spectral moments and significant wave height.

As compared to prior art buoys and wave measurement devices, wave measurement device 2 and the method of FIG. 4 offer several distinctions. The innovation takes advantage of modern MEMS-based sensors and sensor fusion algorithms to take measurements of the ocean surface. The subject invention uses a rotation matrix or quaternions to determine absolute rotation of a buoy, whereas previously the rotation matrix was predominantly used in aircraft navigation devices to correct the orientation and motion of the aircraft. The use of these algorithms prevents singularities, such as gimbal lock, and excess signal noise in previously implemented accelerometer based surface wave measurement systems, as discussed in the previously cited U.S. Pat. No. 8,195,395. In the present invention, the buoy orientation determined from the motion sensor fusion is used to obtain a corrected acceleration signal that is subsequently used to estimate wave motion in real-time or near real-time. As a result, the subject invention is capable of tracking the motion of buoy 1 and providing wave height and directional information as the wave passes rather than having to spectrally filter the data subsequently to reduce noise. Additionally, the buoy can continue to function in any orientation (e.g. upside down).

FIGS. 5A-F provide illustrative examples of time series data generated by wave measurement device 2. FIG. 5A provides frequency domain wave acceleration data, referred to as the power spectral density of acceleration while FIG. 5B provides time domain acceleration time series data for a 30 second time interval. Similarly, FIG. 5C provides frequency domain velocity data while FIG. 5D provide time domain wave velocity data for a thirty second interval. FIG. 5E provides vertical displacement, otherwise known as wave height, frequency domain data while FIG. 5F provides time domain wave height (in meters) data for a 30 second time interval. FIG. 5E essentially plots S(f), the wave spectrum function.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for estimating wave motion, comprising:
receiving by a wave measurement device 3D sensor data from each of an accelerometer and a gyroscope, the wave measurement device mounted within a buoy, said buoy moored in an ocean;
determining, by the wave measurement device, an absolute orientation of the buoy based on said 3D sensor data; and
estimating, by the wave measurement device, a true earth acceleration of the buoy over a specified time interval;

2. The method of claim 1, further comprising:
calculating, by the wave measurement device, a power spectral density of acceleration in the frequency domain,
computing, by the wave measurement device, an omnidirectional wave energy spectrum.

3. The method of claim 2, further comprising:
transmitting the omnidirectional wave energy spectrum to a remote computer for further processing or display.

4. The method of claim 2 wherein a Fast Fourier Transform is used to determine the power spectral density of acceleration.

5. The method of claim 2, wherein the inertial measurement unit further includes a magnetometer, the method further comprising:
receiving 3D sensor data from the magnetometer;
computing the x and y plane horizontal components of true earth acceleration, referenced to magnetic North, and
computing a directional spectral density.

6. The method of claim 2 further comprising computing, over a time interval, at least one member of the group consisting of significant wave height, peak wave period, and directional spectra.

7. The method of claim 1 wherein determining absolute buoy orientation is performed using a direct cosine matrix and a complimentary filter.

8. The method of claim 1 wherein determining absolute buoy orientation is performed using a quaternion.

9. A buoy that estimates wave motion, comprising:
a housing;
a power source, attached to the housing;
an inertial measurement unit, attached to the housing, that includes an accelerometer and a gyroscope, each of which provides a time series of 3D sensor data;
a data storage for storing program code and data; and
a processor in communication with the inertial measurement unit and the data storage, that is programmed to perform instructions that cause the processor:
to determine an absolute orientation of the buoy based on said 3D sensor data; and
to estimate a true earth acceleration of the buoy over a specified time interval.

10. The buoy of claim 9 wherein the instructions further cause the processor:
to calculate a power spectral density of acceleration in the frequency domain, and
to determine an omnidirectional wave energy spectrum.

11. The buoy of claim 10, wherein the instructions further cause the processor:
to transmit the omnidirectional wave energy spectrum to a remote computer for further processing or display.

12. The buoy of claim 10 wherein a Fast Fourier Transform is used to calculate the power spectral density of acceleration.

13. The buoy of claim 10, wherein the inertial measurement unit further includes a magnetometer and wherein the instructions further cause the processor:
to receive 3D sensor data from the magnetometer;
to compute the x and y plane horizontal components of true earth acceleration, referenced to magnetic North, and
to compute a directional spectral density.

14. The buoy of claim 10 wherein the instructions further cause the processor:
to compute, over a time interval, at least one member of the group consisting of significant wave height, peak wave period, and directional spectra.

15. The buoy of claim 9 wherein determining absolute buoy orientation is performed using a direct cosine matrix and a complimentary filter.

16. The buoy of claim 9 wherein determining absolute buoy orientation is performed using a quaternion.
